(19) United States
(12) Patent Application Publication
(10) Pub. No.: US 2025/0056414 A1
(43) Pub. Date: Feb. 13, 2025

(54) METHOD FOR SIGNAL PROCESSING

(71) Applicant: ZTE CORPORATION, Shenzhen (CN)

(72) Inventors: Xuan MA, Shenzhen (CN); Mengzhu CHEN, Shenzhen (CN); Jun XU, Shenzhen (CN); Bo DAI, Shenzhen (CN); Xiaoying MA, Shenzhen (CN); Qiujin GUO, Shenzhen (CN)

(73) Assignee: ZTE CORPORATION, Shenzhen (CN)

(21) Appl. No.: 18/930,564

(22) Filed: Oct. 29, 2024

Related U.S. Application Data
(63) Continuation of application No. PCT/CN2022/123376, filed on Sep. 30, 2022.

(51) Int. Cl. H04W 52/02; H04W 24/10; H04W 56/00; H04W 72/1268; H04W 72/21; H04W 74/0833

(52) U.S. Cl. CPC H04W 52/0235; H04W 24/10; H04W 56/0015; H04W 72/1268; H04W 72/21; H04W 74/0833

(57) ABSTRACT

A wireless communication method is disclosed. The method comprises transmitting, by a wireless communication terminal to a wireless communication node, a wake-up request comprising wake-up information in one or more wake-up occasions, wherein the wake-up information comprises at least one of a cell activation request, a cell deactivation request, or a feedback information to the wireless communication node.

### CROSS-REFERENCE TO RELATED APPLICATION

This application claims the benefit of priority under 35 U.S.C. § 120 as a continuation of International Patent Application No. PCT/CN2022/123376, filed on Sep. 30, 2022, the disclosure of which is incorporated herein by reference in its entirety.

### TECHNICAL FIELD

This document is directed generally to wireless communications, and in particular to 5^{th} generation (5G) communications.

### BACKGROUND

The bandwidth of the 5G cell is more than five times of that of the 4G cell. In addition, the 64/32-channel Massive MIMO equipment with high complexity is used outdoors, leading to extremely high power consumption of the 5G base station.

Currently, the gNodeB (gNB) can reduce power consumption by using some energy saving technologies, such as channel shutdown, carrier shutdown, etc.

### SUMMARY

According to the current specification, cell can be de-activated for energy saving. With this solution, NW has to handover the UEs to other cells, which has large impact on system performance.

Furthermore, the UE cannot access the cell when it is needed, which influences the user experience. Therefore, it is necessary to find a solution to ensure energy saving and minimize the impact on user experience.

Switching to a sleep mode or turning off some RF components, when they are not needed, are effective methods to reduce network power consumption. For example, if there is no UE access, the carrier can be deactivated. When the traffic load is low, the number of Tx/Rx antennas can be reduced.

For NR, the cell activation and deactivation are triggered by the network device without the UE's feedback. However, when the UE moves to a new cell or a burst service occur, the base station cannot obtain the requirement in a timely manner, which will cause great delay and affect user experience.

In order to overcome the above problems, the present disclosure proposes several methods and systems, as exemplified in the following examples and embodiments.

One aspect of the present disclosure relates to a wireless communication method. In an embodiment, the wireless communication method includes: transmitting, by a wireless communication terminal to a wireless communication node, a wake-up request comprising wake-up information in one or more wake-up occasions, wherein the wake-up information comprises at least one of a cell activation request, a cell deactivation request, or a feedback information to the wireless communication node.

Another aspect of the present disclosure relates to a wireless communication method. In an embodiment, the wireless communication method includes: receiving, by a wireless communication node from a wireless communication terminal, a wake-up request comprising wake-up information in one or more wake-up occasions, wherein the wake-up information comprises at least one of a cell activation request, a cell deactivation request, or a feedback information to the wireless communication node.

Another aspect of the present disclosure relates to a wireless communication terminal. In an embodiment, the wireless communication terminal includes a transceiver and a processor. The processor is configured to: transmit, via the transceiver to a wireless communication node, a wake-up request comprising wake-up information in one or more wake-up occasions, wherein the wake-up information comprises at least one of a cell activation request, a cell deactivation request, or a feedback information to the wireless communication node.

Another aspect of the present disclosure relates to a wireless communication node. In an embodiment, the wireless communication node includes a transceiver and a processor. The processor is configured to: receive, via the transceiver from a wireless communication terminal, a wake-up request comprising wake-up information in one or more wake-up occasions, wherein the wake-up information comprises at least one of a cell activation request, a cell deactivation request, or a feedback information to the wireless communication node.

Various embodiments may preferably implement the following features:

Preferably or in some embodiments, the wake-up request is transmitted according to at least one of: a measurement result, a random access requirement, or a data transmission requirement.

Preferably or in some embodiments, the cell to be activated comprises at least one of: a pre-determined cell, a cell with a specific configuration, a cell where the wireless communication node detects wake-up information, a cell with a coverage range within an activated cell, or a cell adjacent to the connected cell.

Preferably or in some embodiments, the wake-up request is transmitted via a first cell to activate the first cell or a second cell in a specific mode.

Preferably or in some embodiments, the cell deactivation request indicates to deactivate a cell or turn a cell into a specific mode.

Preferably or in some embodiments, the feedback information comprising at least one of: whether to support a network state re-configuration, Radio Resources Management, RRM, measurement information, a capability of the wireless communication terminal, or assistance information of the wireless communication terminal.

Preferably or in some embodiments, activating the cell comprises at least one of: activating a secondary cell, SCell, turning the cell in a specific mode into a normal mode, changing specific configurations on the cell, or starting transmissions of Synchronization Signal/Physical Broadcast Channel Blocks, SSBs, on the cell.

Preferably or in some embodiments, the wake-up request is carried by a sequence-based signal, wherein a generation of the wake-up request is related to at least one of: a state identification, a cell index, a root sequence index, an initialization seed, or a sequence identifier, ID.

Preferably or in some embodiments, the wake-up occasions are associated with at least one of: a high layer parameter, a paging cycle, an SSB transmission period, a discovery burst duty cycle, a predetermined value, one or more system frame numbers, a state transition of the wireless communication node or an indication information.

Preferably or in some embodiments, one or more transmission occasions of the wake-up request are associated with a number of SSB indexes or is a certain number of consecutive occasions, and the certain number is a number of actual transmitted SSBs.

Preferably or in some embodiments, the SSB indexes and the one or more transmission occasions of the wake-up request are mapped in an association period, and a length of the association period is a number of times of a period of the transmission occasions or a number of times of an SSB period.

Preferably or in some embodiments, a reference signal for the wake-up request is configured by one or more higher layer parameters for spatial relation information.

Preferably or in some embodiments, the reference signal comprises at least one of: a CSI-RS resource in an NZP-CSI-RS-ResourceSet, a CSI-RS resource for tracking, a Tracking Reference Signal, TRS, resource, a Sounding Reference Signal, SRS, resource for beamManagement, or an SSB associated with a physical cell ID, PCI, identical to or different from a PCI of a serving cell.

Preferably or in some embodiments, the wake-up information is carried by a sequence-based signal transmitted on the PRACH resource or by one or more random-access preambles with at least one of the following: a specific PRACH preamble format, a specific Radio Network Temporary Identifier, RNTI, or a PRACH resource.

Preferably or in some embodiments, the wake-up information is carried by a Physical Uplink Shared Channel, PUSCH, scheduled by a Random Access Response, RAR, uplink, UL, grant or a PUSCH for a Type-2 random access procedure.

Preferably or in some embodiments, a bit field of the wake-up information is uplink control information, UCI, carried on a PUSCH scheduled by an RAR UL grant or a PUSCH for Type-2 random access procedure.

Preferably or in some embodiments, the wake-up information is multiplexed with one or more Uplink Shared Channel, UL-SCH, bits.

Preferably or in some embodiments, a bit field of the wake-up information comprises one bit indicating to activate a cell or deactivate a cell, or the bit field of the wake-up information comprises more than one bit indicating states for a network.

Preferably or in some embodiments, the wake-up information is carried by a Physical Uplink Control Channel, PUCCH, and in response to more than one fields being transmitted on a PUCCH, a UCI sequence is generated according to a priority configuration, and a field with a high priority is mapped to a front of a UCI sequence.

Preferably or in some embodiments, the UCI sequence is multiplexed with a PUSCH according to at least one of: a priority index or a default configuration.

Preferably or in some embodiments, in response to the wake-up request and a UL transmission being overlapped in a same slot on a serving cell, the wake-up request is transmitted according to at least one of a priority index or a default configuration.

Preferably or in some embodiments, in response to the wake-up request and a UL transmission being overlapped in a same slot on a serving cell, one of the wake-up request and the UL transmission with a lower priority is not transmitted or is transmitted after another one of the wake-up request and the UL transmission with a higher priority is transmitted.

The present disclosure also relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 shows a schematic diagram of a wireless terminal according to an embodiment of the present disclosure.

FIG. 2 shows a schematic diagram of a wireless network node according to an embodiment of the present disclosure.

FIGS. 3 and 4 shows flowcharts for wireless communication methods according to an embodiment of the present disclosure.

### DETAILED DESCRIPTION

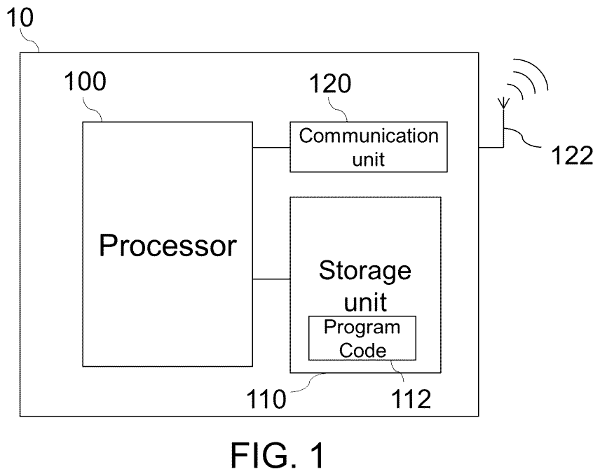

FIG. 1 relates to a schematic diagram of a wireless terminal (e.g., wireless communication terminal) 10 according to an embodiment of the present disclosure. The wireless terminal 10 may be a user equipment (UE), a mobile phone, a laptop, a tablet computer, an electronic book or a portable computer system and is not limited herein. The wireless terminal 10 may include a processor 100 such as a microprocessor or Application Specific Integrated Circuit (ASIC), a storage unit 110 and a communication unit 120. The storage unit 110 may be any data storage device that stores a program code 112, which is accessed and executed by the processor 100. Embodiments of the storage unit 112 include but are not limited to a subscriber identity module (SIM), read-only memory (ROM), flash memory, random-access memory (RAM), hard-disk, and optical data storage device. The communication unit 120 may a transceiver and is used to transmit and receive signals (e.g., messages or packets) according to processing results of the processor 100. In an embodiment, the communication unit 120 transmits and receives the signals via at least one antenna 122 shown in FIG. 1.

In an embodiment, the storage unit 110 and the program code 112 may be omitted and the processor 100 may include a storage unit with stored program code.

The processor 100 may implement any one of the steps in exemplified embodiments on the wireless terminal 10, e.g., by executing the program code 112.

The communication unit 120 may be a transceiver. The communication unit 120 may as an alternative or in addition be combining a transmitting unit and a receiving unit configured to transmit and to receive, respectively, signals to and from a wireless network node (e.g., a base station).

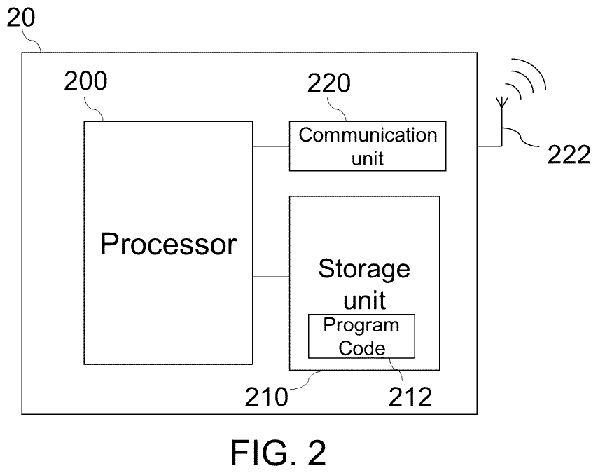

FIG. 2 relates to a schematic diagram of a wireless network node (e.g., wireless communication node) 20 according to an embodiment of the present disclosure. The wireless network node 20 may be a satellite, a base station (BS), a smart node, a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 20 may comprise (perform) at least one network function such as an access and mobility management function (AMF), a session management function (SMF), a user place function (UPF), a policy control function (PCF), an application function (AF), etc. The wireless network node 20 may include a processor 200 such as a microprocessor or ASIC, a storage unit 210 and a communication unit 220. The storage unit 210 may be any data storage device that stores a program code 212, which is accessed and executed by the processor 200. Examples of the storage unit 212 include but are not limited to a SIM, ROM, flash memory, RAM, hard-disk, and optical data storage device. The communication unit 220 may be a transceiver and is used to transmit and receive signals (e.g., messages or packets) according to processing results of the processor 200. In an example, the communication unit 220 transmits and receives the signals via at least one antenna 222 shown in FIG. 2.

In an embodiment, the storage unit 210 and the program code 212 may be omitted. The processor 200 may include a storage unit with stored program code.

The processor 200 may implement any steps described in exemplified embodiments on the wireless network node 20, e.g., via executing the program code 212.

The communication unit 220 may be a transceiver. The communication unit 220 may as an alternative or in addition be combining a transmitting unit and a receiving unit configured to transmit and to receive, respectively, signals to and from a wireless terminal (e.g., a user equipment or another wireless network node).

In an embodiment, the UE may transmit a wake-up request (e.g., a wake-up signal or channel) (referred to as WUS hereinafter)) on the WUS occasions, to a network device (e.g., a base station), wherein the wake-up signal or channel comprises a wake-up information, and indicates the operation of the network device.

### WUS Comprising Cell Activation Request

In an embodiment, the wake-up information comprises a cell activation request.

In some embodiments, whether the UE transmits the wake-up signal or channel is associated with at least one of the following: the measurement results (e.g., the UE transmits the WUS when the RSRP is lower than a threshold, or the UE doesn't detects any of the SSB, CSI-RS within a duration), the data transmission requirement (e.g., UE has burst services to transmit, or the UE has a large amount of uplink data transmission requirements), the random access requirement.

In some embodiments, the specific cell to be activated is associated with at least one of the following: a pre-determined cell, a cell with specific configuration (e.g., a sleep cell, a dormant cell, an energy saving cell or a SSB-less cell), a cell where the network device detects the wake-up information, a cell whose coverage range is within the connected cell or a cell adjacent to the connected cell, where the connected cell is an activated cell.

In some embodiments, the network device detects the wake-up signal/channel on the specific cell, and activates the specific cell when the wake-up information is received. For example, the UE transmits a wake-up signal/channel when the RSRP is lower than a threshold, the network device detects the wake-up signal/channel on the specific cell, when the wake-up information is detected, the network device activates the specific cell. In some embodiments, the network device detects the wake-up signal/channel on the normal cell, and activates the specific cell when the wake-up information is received. For example, the UE transmits a wake-up signal/channel with a cell activation request on the connected cell when there is a large amount of uplink data need to be transmitted, the network device detects the wake-up signal/channel on the connected cell, and activates the specific cell.

In some embodiments, on the UE side, the UE transmits the wake-up signal/channel on the SpCell cell. For example, the UE transmits a wake-up signal/channel when there is a large amount of uplink data need to be transmitted. in some other embodiments, the UE transmits the wake-up signal/channel on the specific cell. The configuration of the WUS can be obtained from the anchor cell, wherein the anchor cell can be a SpCell, a cell in the same TAG with the specific cell or a cell has same coverage area.

### WUS Comprising Cell Deactivation Request

In an embodiment, the UE transmits the wake-up signal/channel with a cell deactivation request when there is no UL transmission requirement within a duration or when the UE can obtain the synchronization information, the SIB from another cell.

### WUS Comprising a Feedback Information to the Network

In an embodiment, the feedback information comprises one or more of the following: whether to support the network state re-configuration, RRM measurement information (for example, the information is related to at least one of the values of RSRP, RSRQ, RSSI, and SINR), UE capability, or UE assistance information (e.g., UE capability, UE requirement for the delay, the bandwidth UE prefer, the service scenario of UE).

### WUS Comprising an Indication Indicates the DL Signals or Channel Transmission

In an embodiment, the DL signals or channel comprises at least one of SSBs, on-demand RS, TRS, or CSI-RS. When the WUS is detected, the network transmits the DL signals or channel with a predetermined manner. For example, the network transmits the DL signals or channel N times, or the network transmits the DL signals or channel within a duration.

In an embodiment, the cell deactivation operation refers to that the cell is deactivated, or the cell is turned to an specific cell, such as, the cell is a sleep cell, a dormant cell, an energy saving cell or a SSB-less cell.

In an embodiment, the cell activation operation refers to at least one of: activate a SCell, turn a specific cell, such as, ends the sleep state of the SCell to a normal cell, changes the energy saving configurations (e.g. lower bandwidth and/or less common signal transmission) on the SCell; or starts transmitting SSBs on the SCell.

### WUS With Wake-Up Indication Information Carried in a Sequence-Based Signal

In an embodiment, the wake-up indication information carried in a sequence-based signal.

### 1) Generation of the Wake-Up Signal

In some embodiments, the format of the wake-up signal is based on ZC (Zadoff Chu) sequence, or PN (pseudo noise) sequence.

In some embodiments, the generation of the of the wake-up signal is related to at least one of the following: a state identification (e.g., a state index, activation or deactivation indication), a cell index, a root sequence index, an initialization seed, or a sequence ID. For example, the different wake-up indication information may correspond to different root sequence index, the wake-up indication information can be detected according to different root sequence index. In another example, the different wake-up indication information may correspond to different initialization seed, each initialization seed corresponds to one function of the WUS.

### 2) Transmission Occasion of the Wake-Up Signal

In some embodiments, the transmission occasion is periodical, the transmission occasion period of the signal is determined by (or associated to) at least one of: high layer configuration (e.g., there are a set of transmission occasion period configured, and one of them can be chosen), a paging cycle (e.g., the transmission occasion period of the signal equals to the paging cycle or equals to the multiple of the paging cycle), a SSB transmission period, a discovery burst duty cycle or a pre-determined value (e.g., the transmission occasion only exists on the specified SFN (system frame number), therefore, the number of transmission occasions allowed on 1024 radio frames determines the transmission occasion period).

In some embodiments, the transmission occasion is on the specific SFN. For example, the specific SFN is equal to N times of a fixed value. In another example, the specific SFN is equal to 0, that is the transmission occasion only exists on the frame 0.

In some embodiments, the transmission occasion is determined by (or associated to) at least one of the following: a gNB state transition, an indication information (e.g., an indication information carried by SIB).

In some embodiments, the transmission occasion is associated with a duty cycle and an SSB.

### 3) Transmission Occasion Mapping With SSB

In some embodiments, the transmission occasion of the wake-up signal is associated with a number N of SS/PBCH block indexes. When N is larger than 1, the wake-up signal transmitted on the transmission resource associates with the SS/PBCH block index is in increasing order. For examples, N=2, the first half of the wake-up signal resource corresponds to SS/PBCH block index=0, and the second half of the wake-up signal resource corresponds to SS/PBCH block index=1. The wake-up signal resource can be sorted with an increasing order of frequency resource indexes for frequency multiplexed WUS transmission occasions, with an increasing order of time resource indexes for time multiplexed WUS transmission occasions, and/or with an increasing order of indexes for WUS transmission slots.

In some embodiments, the transmission occasion of the wake-up signal is S consecutive occasions, wherein S is the number of actual transmitted SSBs. Each WUS transmission occasion corresponds to one SS/PBCH block indexes. In some embodiments, only N of S WUS occasion are used for WUS transmission, where, the N occasions correspond to the N SS/PBCH block index with the best measurement result.

In some embodiments, the SS/PBCH block indexes to WUS transmission occasions are mapped in an association period. In some embodiments, the association period is from frame 0. In some embodiments, the association period is certain times of the WUS transmission occasion period. In some embodiments, the association period is certain times of the SSB period.

In some embodiments, when the WUS occasions not associated with SS/PBCH block indexes or the SSB associated with WUS occasion not. In some embodiments, when the WUS occasions are not associated with SS/PBCH block indexes or the SSB associated with WUS occasion do not exist, the occasions are used for WUS transmission with a reference of at least one of the following: the nearest PRACH occasion, a history transmission information, a default configuration, an SRS resource, a CSI-RS resource, a SSB transmitted on the other cell.

### 4) WUS Resource

In some embodiments, the WUS only transmitted on the SpCell. In some embodiments, the WUS transmitted on the cell to be activated.

In some embodiments, the WUS resource sets may be configured by the higher layer parameter. In each resource set, R≥1 WUS resource can be configured, each resource corresponds to one of the wake-up indication sequences.

In some embodiments, a reference RS for the WUS is configured by one or more high layer parameters for spatial relation information. The reference RS is one or more of the following: CSI-RS resource in an NZP-CSI-RS-ResourceSet, or a CSI-RS resource for tracking, a TRS resource, an SRS resource for ‘beamManagement’, or SS/PBCH block associated with the same or different PCI from the PCI of the serving cell.

### WUS With Wake-Up Indication Information Carried by a RA-Based Channel

### WUS With Wake-Up Indication Information Carried by a PRACH

In an embodiment, the wake-up indication information carried by a physical random access channel (PRACH).

In some embodiments, the wake-up indication information is carried by one or more random-access preambles with at least one of the following: a specific PRACH preamble format, a specific RNTI, a PRACH resource.

In some embodiments, the wake-up indication information is carried by a sequence-based signal transmitted on the PRACH resource.

### WUS With Wake-Up Indication Information Carried by a PUSCH

In an embodiment, the wake-up indication is carried by a PUSCH scheduled by a RAR UL grant or a PUSCH for Type-2 random access procedure.

In some embodiments, the wake-up indication bit field is uplink control information (UCI) carried on a PUSCH scheduled by a RAR UL grant or a PUSCH for Type-2 random access procedure.

In some embodiments, the wake-up indications are multiplexed with the UL-SCH bits, if any. When there are more than 1 control information are carried on a PUSCH, the UCI bit sequences are generated associated with a priority index. For example, the wake-up indication bits transmitted on a PUSCH associated with priority index 1, another indication bit, if any, are transmitted on the PUSCH associated with priority index 0, then the UCI sequence can be generated as a₀, a₁, a₂, a₃, . . . , a_{A-1}, a₀⁽¹⁾, a₁⁽¹⁾, a₂⁽¹⁾, a₃⁽¹⁾, . . . , a_{A}_{⁽¹⁾}₋₁⁽¹⁾, wherein A is the number of coded bits for wake-up indication, A⁽¹⁾ is the number of bits for another indication, if any. When there is only wake-up indication bits and UL-SCH transmitted on the PUSCH, the wake-up indications are multiplexed with the data coded bit.

In some embodiments, the wake-up indication bit field comprises one bit.

In some embodiments, value A of the bit field indicates changes the current configurations, the value B indicates maintains the current configurations.

In some embodiments, value A of the bit field indicates a first configurations, the value B indicates a second configurations.

In some embodiments, value A of the bit field indicates support the state re-configuration, the value B indicates not support state re-configuration.

In some embodiments, value A of the bit field indicates activate a SCell, the value B indicates deactivate a SCell. And A is equals to 0, B is equals to 1; or A is equals to 1, B is equals to 0.

In some embodiments, the wake-up indication bit field comprises T bits, T>1. In some examples, T is determined by (or associated to) the number of states (N) configured for network, e.g., T=ceil(log 2N), where ceil(x) means round up to an integer.

### WUS With Wake-Up Indication Information Carried by a PUCCH

In an embodiment, the wake-up indication is carried by a PUCCH.

In some embodiments, if only wake-up indication bits are transmitted on a PUCCH, the wake-up indication bits are mapped to the UCI bit sequence as a₀, a₁, a₂, a₃, . . . , a_{A-1}, wherein A is the number of coded bits for wake-up indication. When there are more than one fields are transmitted on a PUCCH, the UCI sequence generation is associated with a priority configuration, the fields with high priority will be mapped to the front of the UCI sequence. In some examples, each field transmitted on the PUCCH is configured with a priority index. For example, the wake-up indication is associated with a priority index 0, and HARQ-ACK bits associated with priority index 1 are transmitted on a PUCCH, the UCI bit sequences are generated as a₀, a₁, a₂, a₃, . . . , a_{A-1}, a₀⁽¹⁾, a₁⁽¹⁾, a₂⁽¹⁾, a₃⁽¹⁾, . . . , a_{A}_{⁽¹⁾}₋₁⁽¹⁾, where A is the bit length of wake-up indication and A(1) is the bit length of HARK-ACK.

In some embodiments, the UCI can be multiplexed with PUSCH according to at least one of: a priority index or a default configuration.

In some embodiments, the wake-up indication bit field comprises one bit.

In some embodiments, value A of the bit field indicates changes the current configurations, the value B indicates maintains the current configurations.

In some embodiments, value A of the bit field indicates a first configurations, the value B indicates a second configurations.

In some embodiments, value A of the bit field indicates support the state re-configuration, the value B indicates not support state re-configuration.

In some embodiments, value A of the bit field indicates activate a SCell, the value B indicates deactivate an SCell. And A is equals to 0, B is equals to 1; or A is equals to 1, B is equals to 0.

In some embodiments, the wake-up indication bit field comprises T bits, T>1. In some examples, T is determined by (or associated to) the number of states (N) configured for network, e.g., T=ceil(log 2N), where ceil(x) means round up to an integer.

### WUS With Wake-Up Indication Information Carried by a PUSCH Scheduled by a DCI.

In an embodiment, the WUS with wake-up indication information carried by a PUSCH scheduled by a DCI.

In some embodiments, the WUS is the feedback of the gNB request. The WUS comprises a bit field, where value A of the bit field indicates support to change the current configurations, the value B indicates support to maintain the current configurations. And A is equals to 0, B is equals to 1; or A is equals to 1, B is equals to 0.

### WUS With Wake-Up Indication Information Carried by a High Layer Signaling

In an embodiment, the wake-up indication is carried by a high layer signaling, e.g., a MAC CE or RRC signaling.

In some embodiments, the wake-up indication is carried by an SRS-based signal.

### Resource Conflict

In an embodiment, when the WUS and other UL transmissions (e.g., SRS, PUCCH, PUSCH, PRACH) are overlapped in the same slot on a serving cell, the UE transmits the signal or channel according to at least one of the following: a priority index, a default configuration. Where the priority index is configured by one or more high layer parameters.

For example, the UE does not transmit the WUS when the WUS occasions are in conflict with a PRACH resource by default. In another example, if a PUSCH or a PUCCH with a high priority level would overlap in time with an WUS transmission on a serving cell, the UE does not transmit the WUS in the overlapping symbol(s).

In some embodiments, when the WUS and other UL transmission are overlapped in the same slot on a serving cell, the low-priority signals or channels are not transmitted.

In some embodiments, when the WUS and other UL transmission are overlapped in the same slot on a serving cell, the signal or channel with a low priority is transmitted after the signal or channel with a high priority is transmitted.

In some embodiments, if a PUSCH and WUS are transmitted in the same slot on a serving cell, the UE may be configured to transmit WUSS after the transmission of the PUSCH and the corresponding DM-RS when the PUSCH is configured with a high priority level.

In some embodiments, if a PUCCH or PUSCH with a high priority level would overlap in time with an WUS transmission on a serving cell, the UE does not transmit the WUS in the overlapping symbol(s).

### Resource Configuration

In an embodiment, the resource for WUS occasion is configured by at least one of the following: SIB, RRC, core network, NAS (Non-Access Stratum).

In some embodiments, the resource for WUS occasion is the same in one or more cells, or one or more tracking areas, or one or more RAN notification areas.

In some other embodiments, the resource for WUS occasion is available for the cell to be activated and the specific cell. The specific cell is at least one of the following the cell configured by RRC, core network, or NAS: a PCell, a PSCell, a cell belonging to the same TAG (Timing advance group) with the cell to be activated, a cell belonging to the same frequency range with the cell to be activated

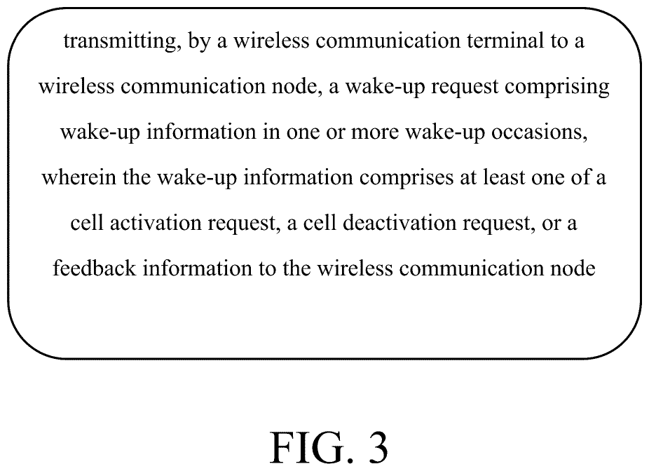

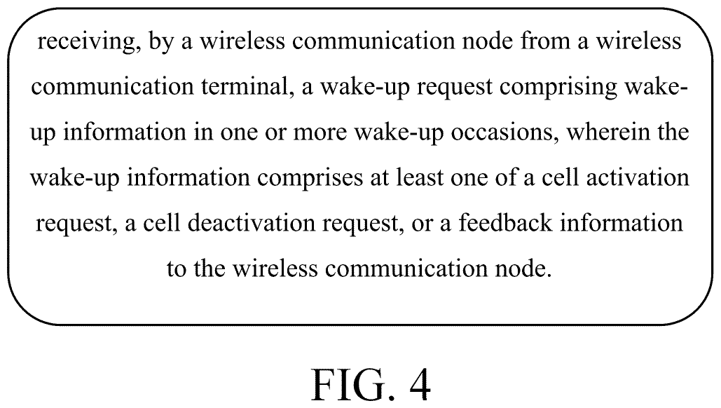

FIGS. 3 and 4 shows flowcharts for wireless communication methods according to an embodiment of the present disclosure.

A wireless communication method is provided according to an embodiment of the present disclosure. In an embodiment, the wireless communication method may be performed by using a wireless communication terminal (e.g., a UE). In an embodiment, the wireless communication terminal may be implemented by using the wireless communication terminal 70 described above, but is not limited thereto.

As illustrated in FIG. 3, in an embodiment, the wireless communication method includes: transmitting, by a wireless communication terminal to a wireless communication node, a wake-up request comprising wake-up information in one or more wake-up occasions, wherein the wake-up information comprises at least one of a cell activation request, a cell deactivation request, or a feedback information to the wireless communication node.

Details in this regard can be ascertained with reference to the paragraphs above, and will not be repeated herein.

Another wireless communication method is provided according to an embodiment of the present disclosure. In an embodiment, the wireless communication method may be performed by using a wireless communication node (e.g., a base station or a gNB). In an embodiment, the wireless communication terminal may be implemented by using the wireless communication node 80 described above, but is not limited thereto.

As illustrated in FIG. 4, in an embodiment, the wireless communication method includes: receiving, by a wireless communication node from a wireless communication terminal, a wake-up request comprising wake-up information in one or more wake-up occasions, wherein the wake-up information comprises at least one of a cell activation request, a cell deactivation request, or a feedback information to the wireless communication node.

Details in this regard can be ascertained with reference to the paragraphs above, and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

What is claimed is:

1. A wireless communication method comprising:
transmitting, by a wireless communication terminal to a wireless communication node, a wake-up request comprising wake-up information in one or more wake-up occasions, wherein the wake-up information comprises at least one of a cell activation request, a cell deactivation request, or a feedback information to the wireless communication node.

2. The wireless communication method of claim 1, wherein the wake-up request is transmitted according to at least one of: a measurement result, a random access requirement, or a data transmission requirement;
wherein the cell to be activated comprises at least one of: a pre-determined cell, a cell with a specific configuration, a cell where the wireless communication node detects wake-up information, a cell with a coverage range within an activated cell, or a cell adjacent to the connected cell;
wherein the wake-up request is transmitted via a first cell to activate the first cell or a second cell in a specific mode;
wherein the cell deactivation request indicates to deactivate a cell or turn a cell into a specific mode.

3. The wireless communication method of claim 1, wherein the feedback information comprises at least one of: whether to support a network state re-configuration, Radio Resources Management (RRM) measurement information, a capability of the wireless communication terminal, or assistance information of the wireless communication terminal;
wherein activating the cell comprises at least one of: activating a secondary cell (SCell) turning the cell in a specific mode into a normal mode, changing specific configurations on the cell, or starting transmissions of Synchronization Signal/Physical Broadcast Channel Blocks (SSBs) on the cell.

4. The wireless communication method of claim 1, wherein the wake-up request is carried by a sequence-based signal, wherein a generation of the wake-up request is related to at least one of: a state identification, a cell index, a root sequence index, an initialization seed, or a sequence identifier (ID).

5. The wireless communication method of claim 1, wherein the wake-up occasions are associated with at least one of: a high layer parameter, a paging cycle, an SSB transmission period, a discovery burst duty cycle, a predetermined value, one or more system frame numbers, a state transition of the wireless communication node or an indication information;
wherein one or more transmission occasions of the wake-up request are associated with a number of SSB indexes or is a certain number of consecutive occasions, and the certain number is a number of actual transmitted SSBs; wherein the SSB indexes and the one or more transmission occasions of the wake-up request are mapped in an association period, and a length of the association period is a number of times of a period of the transmission occasions or a number of times of an SSB period.

6. The wireless communication method of claim 1, wherein a reference signal for the wake-up request is configured by one or more higher layer parameters for spatial relation information;
wherein the reference signal comprises at least one of: a CSI-RS resource in an NZP-CSI-RS-ResourceSet, a CSI-RS resource for tracking, a Tracking Reference Signal (TRS) resource, a Sounding Reference Signal (SRS) resource for beamManagement, or an SSB associated with a physical cell ID (PCI) identical to or different from a PCI of a serving cell.

7. The wireless communication method of claim 1, wherein the wake-up information is carried by a sequence-based signal transmitted on a physical random access channel (PRACH) resource or by one or more random-access preambles with at least one of the following: a specific PRACH preamble format, a specific Radio Network Temporary Identifier (RNTI) or a PRACH resource.

8. The wireless communication method of claim 1, wherein the wake-up information is carried by a Physical Uplink Shared Channel (PUSCH) scheduled by a Random Access Response (RAR), uplink (UL) grant or a PUSCH for a Type-2 random access procedure; wherein a bit field of the wake-up information is uplink control information (UCI) carried on a PUSCH scheduled by an RAR UL grant or a PUSCH for Type-2 random access procedure; wherein the wake-up information is multiplexed with one or more Uplink Shared Channel (UL-SCH) bits; wherein a bit field of the wake-up information comprises one bit indicating to activate a cell or deactivate a cell, or the bit field of the wake-up information comprises more than one bit indicating states for a network.

9. The wireless communication method of claim 1, wherein the wake-up information is carried by a Physical Uplink Control Channel (PUCCH) and in response to more than one fields being transmitted on a PUCCH, a UCI sequence is generated according to a priority configuration, and a field with a high priority is mapped to a front of a UCI sequence;
wherein the UCI sequence is multiplexed with a PUSCH according to at least one of: a priority index or a default configuration.

10. The wireless communication method of claim 1, wherein in response to the wake-up request and a UL transmission being overlapped in a same slot on a serving cell, the wake-up request is transmitted according to at least one of a priority index or a default configuration;
wherein in response to the wake-up request and a UL transmission being overlapped in a same slot on a serving cell, one of the wake-up request and the UL transmission with a lower priority is not transmitted or is transmitted after another one of the wake-up request and the UL transmission with a higher priority is transmitted.

11. A wireless communication method comprising:
receiving, by a wireless communication node from a wireless communication terminal, a wake-up request comprising wake-up information in one or more wake-up occasions, wherein the wake-up information comprises at least one of a cell activation request, a cell deactivation request, or a feedback information to the wireless communication node.

12. The wireless communication method of claim 11, wherein the wake-up request is transmitted according to at least one of: a measurement result, a random access requirement, or a data transmission requirement;
wherein the cell to be activated comprises at least one of: a pre-determined cell, a cell with a specific configuration, a cell where the wireless communication node detects wake-up information, a cell with a coverage range within an activated cell, or a cell adjacent to the connected cell;
wherein the wake-up request is transmitted via a first cell to activate the first cell or a second cell in a specific mode;
wherein the cell deactivation request indicates to deactivate a cell or turn a cell into a specific mode.

13. The wireless communication method of claim 11, wherein the feedback information comprising at least one of: whether to support a network state re-configuration, Radio Resources Management (RRM) measurement information, a capability of the wireless communication terminal, or assistance information of the wireless communication terminal;
wherein activating the cell comprises at least one of: activating a secondary cell (SCell) turning the cell in a specific mode into a normal mode, changing specific configurations on the cell, or starting transmissions of Synchronization Signal/Physical Broadcast Channel Blocks (SSBs) on the cell.

14. The wireless communication method of claim 11, wherein the wake-up request is carried by a sequence-based signal, wherein a generation of the wake-up request is related to at least one of: a state identification, a cell index, a root sequence index, an initialization seed, or a sequence identifier (ID).

15. The wireless communication method of claim 11, wherein the wake-up occasions are associated with at least one of: a high layer parameter, a paging cycle, an SSB transmission period, a discovery burst duty cycle, a predetermined value, one or more system frame numbers, a state transition of the wireless communication node or an indication information;
wherein one or more transmission occasions of the wake-up request are associated with a number of SSB indexes or is a certain number of consecutive occasions, and the certain number is a number of actual transmitted SSBs; wherein the SSB indexes and the one or more transmission occasions of the wake-up request are mapped in an association period, and a length of the association period is a number of times of a period of the transmission occasions or a number of times of an SSB period.

16. The wireless communication method of claim 11, wherein a reference signal for the wake-up request is configured by one or more higher layer parameters for spatial relation information; wherein the reference signal comprises at least one of: a CSI-RS resource in an NZP-CSI-RS-ResourceSet, a CSI-RS resource for tracking, a Tracking Reference Signal (TRS) resource, a Sounding Reference Signal (SRS) resource for beamManagement, or an SSB associated with a physical cell ID (PCI) identical to or different from a PCI of a serving cell.

17. The wireless communication method of claim 11, wherein the wake-up information is carried by a sequence-based signal transmitted on a physical random access channel (PRACH) resource or by one or more random-access preambles with at least one of the following: a specific PRACH preamble format, a specific Radio Network Temporary Identifier (RNTI) or a PRACH resource;
wherein the wake-up information is carried by a Physical Uplink Shared Channel (PUSCH) scheduled by a Random Access Response (RAR), uplink (UL) grant or a PUSCH for a Type-2 random access procedure; wherein a bit field of the wake-up information is uplink control information (UCI) carried on a PUSCH scheduled by an RAR UL grant or a PUSCH for Type-2 random access procedure; wherein the wake-up information is multiplexed with one or more Uplink Shared Channel (UL-SCH) bits; wherein a bit field of the wake-up information comprises one bit indicating to activate a cell or deactivate a cell, or the bit field of the wake-up information comprises more than one bit indicating states for a network.

18. The wireless communication method of claim 11, wherein the wake-up information is carried by a Physical Uplink Control Channel (PUCCH) and in response to more than one fields being transmitted on a PUCCH, a UCI sequence is generated according to a priority configuration, and a field with a high priority is mapped to a front of a UCI sequence; and/or wherein the UCI sequence is multiplexed with a PUSCH according to at least one of: a priority index or a default configuration.

19. The wireless communication method of claim 11, wherein in response to the wake-up request and a UL transmission being overlapped in a same slot on a serving cell, the wake-up request is transmitted according to at least one of a priority index or a default configuration;
wherein in response to the wake-up request and a UL transmission being overlapped in a same slot on a serving cell, one of the wake-up request and the UL transmission with a lower priority is not transmitted or is transmitted after another one of the wake-up request and the UL transmission with a higher priority is transmitted.

20. A wireless communication terminal, comprising:
a transceiver; and
a processor configured to: transmit, via the transceiver to a wireless communication node, a wake-up request comprising wake-up information in one or more wake-up occasions, wherein the wake-up information comprises at least one of a cell activation request, a cell deactivation request, or a feedback information to the wireless communication node.
